(19) United States
(12) Patent Application Publication
(10) Pub. No.: US 2018/0119810 A1
(43) Pub. Date: May 3, 2018

(54) Symmetric Infinitely Variable Transmission Having A Ball-Type Continuously Variable Transmission

(71) Applicant: Dana Limited, Maumee, OH (US)

(72) Inventor: Andrew W. Phillips, Rochester, MI (US)

(21) Appl. No.: 15/857,750

(22) Filed: Dec. 29, 2017

Related U.S. Application Data
(60) Provisional application No. 62/577,262, filed on Oct. 26, 2017.

(51) Int. Cl. F16H 61/664; F16H 63/06; F16H 63/42; F16H 59/40; F16H 37/08; F16H 15/50

(52) U.S. Cl. CPC F16H 61/6645; F16H 63/067; F16H 63/42; F16H 2059/704; F16H 37/084; F16H 15/506; F16H 2037/0866; F16H 59/40

(57) ABSTRACT

Provided herein is a powertrain including: a main shaft; a variator having a first plurality of balls, each ball provided with a tiltable axis of rotation, each ball in contact with a first traction ring assembly and a second traction ring assembly, and each ball operably coupled to a first carrier assembly; a first planetary gear set having a first ring gear, a first planet carrier supporting a first plurality of planet gears coupled to the first ring gear, and a first sun gear coupled to the first plurality of the planet gears; and a second planetary gear set having a second ring gear, a second planet carrier supporting a second plurality of planet gears coupled to the second ring gear, and a second sun gear coupled to the second plurality of the planet gears.

### RELATED APPLICATION

This application claims the benefit of U.S. Provisional Patent Application No. 62/577,262 filed Oct. 26, 2017, which is incorporated herein by reference in its entirety

### BACKGROUND

A driveline including a continuously variable transmission allows an operator or a control system to vary a drive ratio in a stepless manner, permitting a power source to operate at its most advantageous rotational speed.

### SUMMARY

Provided herein is a powertrain including: a main shaft; a variator having a first plurality of balls, each ball provided with a tillable axis of rotation, each ball in contact with a first traction ring assembly and a second traction ring assembly, and each ball operably coupled to a first carrier assembly; a first planetary gear set having a first ring gear, a first planet carrier supporting a first plurality of planet gears coupled to the first ring gear, and a first sun gear coupled to the first plurality of the planet gears; and a second planetary gear set having a second ring gear, a second planet carrier supporting a second plurality of planet gears coupled to the second ring gear, and a second sun gear coupled to the second plurality of the planet gears. The first traction ring assembly is configured to receive a rotational power and is operably coupled to the second sun gear. The second traction ring assembly is operably coupled to the first ring gear. The first planet carrier is operably coupled to the second planet carrier. The first sun gear is operably coupled to ground.

### INCORPORATION BY REFERENCE

All publications, patents, and patent applications mentioned in this specification are herein incorporated by reference to the same extent as if each individual publication, patent, or patent application was specifically and individually indicated to be incorporated by reference.

### BRIEF DESCRIPTION OF THE DRAWINGS

Novel features of the invention are set forth with particularity in the appended claims. A better understanding of the features and advantages of the preferred embodiments will be obtained by reference to the following detailed description that sets forth illustrative embodiments, in which the principles of the invention are utilized, and the accompanying drawings of which:

FIG. 1 is a side sectional view of a ball-type variator.

FIG. 2 is a plan view of a carrier member that is used in the variator of FIG. 1.

FIG. 3 is an illustrative view of different tilt positions of the ball-type variator of FIG. 1.

FIG. 4 is a schematic speed ratio diagram of a powertrain having a ball-type variator and a planetary gear set.

FIG. 5 is a schematic lever diagram of the powertrain depicted in FIG. 4.

FIG. 6 is a schematic diagram of a symmetric infinitely variable transmission.

### DETAILED DESCRIPTION OF THE PREFERRED EMBODIMENTS

The preferred embodiments will now be described with reference to the accompanying figures, wherein like numerals refer to like elements throughout. The terminology used in the descriptions below is not to be interpreted in any limited or restrictive manner simply because it is used in conjunction with detailed descriptions of the preferred embodiments. Furthermore, the preferred embodiments include several novel features, no single one of which is solely responsible for its desirable attributes or which is essential to practicing the embodiments described.

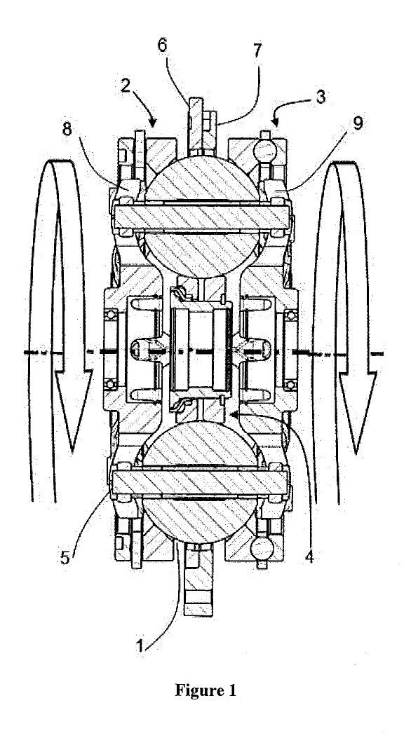

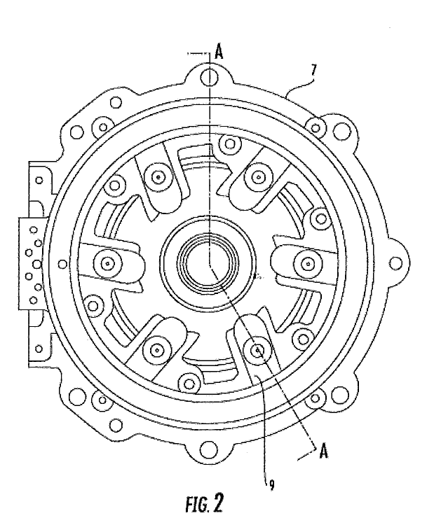

Provided herein are configurations of CVTs based on a ball type variators, also known as CVP, for continuously variable planetary. Basic concepts of a ball type Continuously Variable Transmissions are described in U.S. Pat. Nos. 8,469,856 and 8,870,711 incorporated herein by reference in their entirety. Such a CVT, adapted herein as described throughout this specification, includes a number of balls (planets, spheres) 1, depending on the application, two ring (disc) assemblies with a conical surface contact with the balls, an input (first) 2 and output (second) 3, and an idler (sun) assembly 4 as shown on FIG. 1. Sometimes, the input ring 2 is referred to in illustrations and referred to in text by the label “R1”. The output ring is referred to in illustrations and referred to in text by the label “R2”. The idler (sun) assembly is referred to in illustrations and referred to in text by the label “S”. The balls are mounted on tiltable axles 5, themselves held in a carrier (stator, cage) assembly having a first carrier member 6 operably coupled to a second carrier member 7. Sometimes, the carrier assembly is denoted in illustrations and referred to in text by the label “C”. These labels are collectively referred to as nodes (“R1”, “R2”, “S”, “C”). The first carrier member 6 rotates with respect to the second carrier member 7, and vice versa. In some embodiments, the first carrier member 6 is substantially fixed from rotation while the second carrier member 7 is configured to rotate with respect to the first carrier member, and vice versa. In some embodiments, the first carrier member 6 is provided with a number of radial guide slots 8. The second carrier member 7 is provided with a number of radially offset guide slots 9, as illustrated in FIG. 2. The radial guide slots 8 and the radially offset guide slots 9 are adapted to guide the tiltable axles 5. The axles 5 are adjusted to achieve a desired ratio of input speed to output speed during operation of the CVT. In some embodiments, adjustment of the axles 5 involves control of the position of the first and second carrier members to impart a tilting of the axles 5 and thereby adjusts the speed ratio of the variator. Other types of ball CVTs also exist, like the one produced by Milner, but are slightly different.

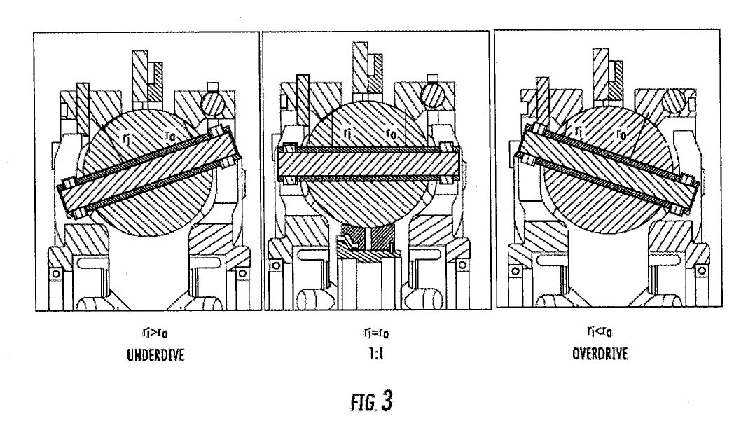

The working principle of such a CVP of FIG. 1 is shown on FIG. 3. The CVP itself works with a traction fluid. The lubricant between the ball and the conical rings acts as a solid at high pressure, transferring the power from the input ring, through the balls, to the output ring. By tilting the balls' axes, the ratio is changed between input and output. When the axis is horizontal the ratio is one, illustrated in FIG. 3, when the axis is tilted the distance between the axis and the contact point change, modifying the overall ratio. All the balls' axes are tilted at the same time with a mechanism included in the carrier and/or idler. The preferred embodiments disclosed here are related to the control of a variator and/or a CVT using generally spherical planets each having a tiltable axis of rotation that is adjusted to achieve a desired ratio of input speed to output speed during operation. In some embodiments, adjustment of said axis of rotation involves angular misalignment of the planet axis in a first plane in order to achieve an angular adjustment of the planet axis in a second plane that is substantially perpendicular to the first plane, thereby adjusting the speed ratio of the variator. The angular misalignment in the first plane is referred to here as “skew”, “skew angle”, and/or “skew condition”. In some embodiments, a control system coordinates the use of a skew angle to generate forces between certain contacting components in the variator that will tilt the planet axis of rotation. The tilting of the planet axis of rotation adjusts the speed ratio of the variator.

As used here, the terms “operationally connected,”“operationally coupled”, “operationally linked”, “operably connected”, “operably coupled”, “operably linked,” and like terms, refer to a relationship (mechanical, linkage, coupling, etc.) between elements whereby operation of one element results in a corresponding, following, or simultaneous operation or actuation of a second element. It is noted that in using said terms to describe preferred embodiments, specific structures or mechanisms that link or couple the elements are typically described. However, unless otherwise specifically stated, when one of said terms is used, the term indicates that the actual linkage or coupling is capable of taking a variety of forms, which in certain instances will be readily apparent to a person of ordinary skill in the relevant technology.

It should be noted that reference herein to “traction” does not exclude applications where the dominant or exclusive mode of power transfer is through “friction.” Without attempting to establish a categorical difference between traction and friction drives here, generally these will be understood as different regimes of power transfer. Traction drives usually involve the transfer of power between two elements by shear forces in a thin fluid layer trapped between the elements. The fluids used in these applications usually exhibit traction coefficients greater than conventional mineral oils. The traction coefficient (μ) represents the maximum available traction force which would be available at the interfaces of the contacting components and is the ratio of the maximum available drive torque per contact force. Typically, friction drives generally relate to transferring power between two elements by frictional forces between the elements. For the purposes of this disclosure, it should be understood that the CVTs described here are capable of operating in both tractive and frictional applications. For example, in the embodiment where a CVT is used for a bicycle application, the CVT operates at times as a friction drive and at other times as a traction drive, depending on the torque and speed conditions present during operation.

For purposes of description, schematics referred to as lever diagrams are used herein. A lever diagram, also known as a lever analogy diagram, is a translational-system representation of rotating parts for a planetary gear system. In certain embodiments, a lever diagram is provided as a visual aid in describing the functions of the transmission. In a lever diagram, a compound planetary gear set is often represented by a single vertical line (“lever”). The input, output, and reaction torques are represented by horizontal forces on the lever. The lever motion, relative to the reaction point, represents direction of rotational velocities. For example, a typical planetary gear set having a ring gear, a planet carrier, and a sun gear is represented by a vertical line having nodes “R” representing the ring gear, node “S” representing the sun gear, and node “C” representing the planet carrier.

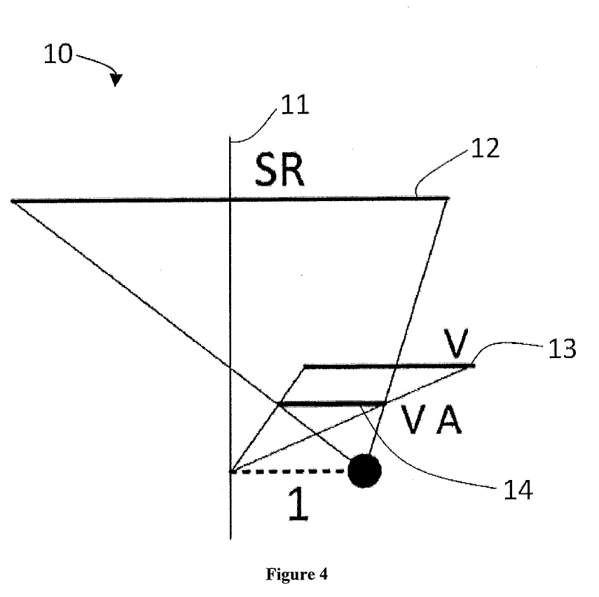

Referring to FIGS. 4-6, one key to efficient power transmission in an infinitely variable transmission (IVT) is to match the output speed ratio exactly to the requirements of the application. Excess speed ratio, in either the forward or reverse directions, corresponds to more power that is wasted as heat in the portion of the ratio range that is unused during operation. The IVT depicted in FIGS. 4-6 provides a symmetric IVT ratio range, as commonly desired for light industrial equipment such as forklift trucks. Power passing through a variator, such as the one described in FIGS. 1-3, operates at a speed reduction at high variator ratio and operates in reverse at low variator ratio.

Turning now to FIG. 4, a speed ratio diagram 10 is depicted to illustrate a symmetric IVT configuration having a ratio range 12 symmetric about a zero ratio line 11. A first horizontal line 13 represents a ratio range of a variable portion of the IVT. A second horizontal line 14 represents a ratio range of a combined variable and fixed ratio portion of the IVT.

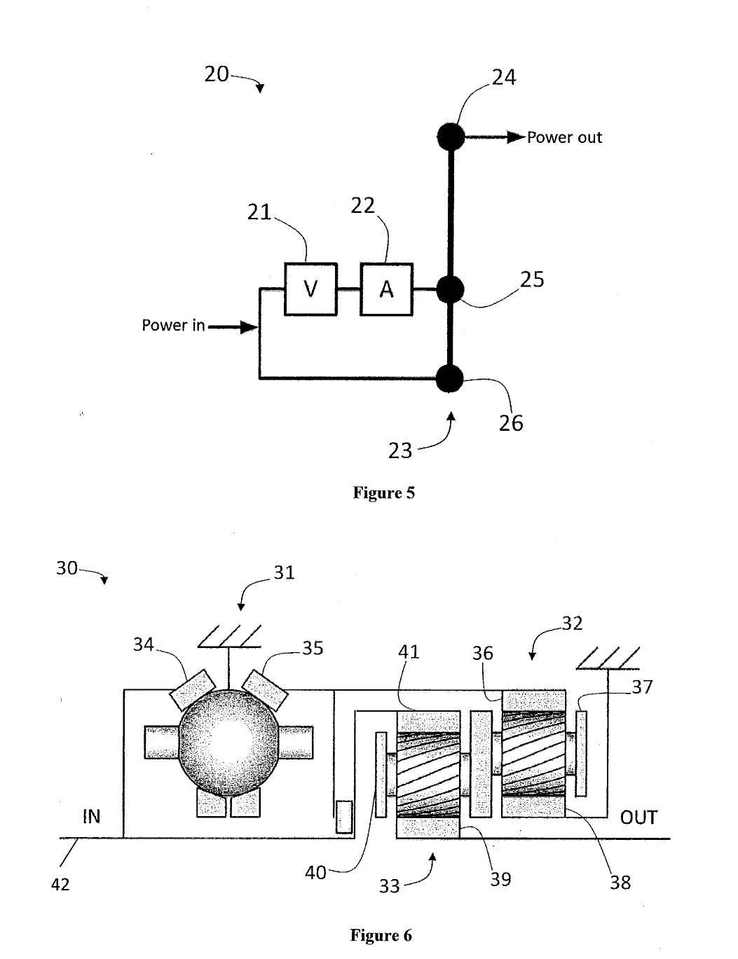

Referring to FIG. 5, in some embodiments, a powertrain 20 is a symmetric infinitely variable transmission. The powertrain 20 includes a variator 21, a fixed ratio gearing 22, and a planetary gear set 23. In some embodiments, the variator 21 is similar the variator depicted in FIGS. 1-3. The planetary gear set 23 includes a ring gear 24 adapted to transmit power out of the powertrain 20, a planet carrier 25 operably coupled to the fixed ratio gearing 22, and a sun gear 26 adapted to receive a power input. In some embodiments, the variator 21 is adapted to receive a power input from a rotational source of power.

Turning now to FIG. 6, in some embodiments, a powertrain 30 is a symmetric infinitely variable transmission. The powertrain 30 includes a main shaft 42, a variator 31, a first planetary gear set 32, and a second planetary gear set 33. The variator 31 is similar to the variator depicted in FIGS. 1-3 and includes a first traction ring assembly 34 and a second traction ring assembly 35. The first planetary gear set 32 includes a first ring gear 36 operably coupled to the second traction ring assembly 35, a first planet carrier 37 operably coupled to the second planetary gear set 33, and a first sun gear 38 operably coupled to a grounded member of the powertrain 30. The second planetary gear set 33 includes a second ring gear 39 adapted to transmit power out of the powertrain 30. The second planetary gear set 33 includes a second planet carrier 40 operably coupled to the first planet carrier 37. The second planetary gear set 33 includes a second sun gear 41 operably coupled to the first traction ring assembly 34 and adapted to receive an input power from a source of rotational power. One example set of ratios which use a variator ratio range of 0.55 to 1.8 to provide a +/−1.62 transmission ratio has a fixed ratio of 0.64, which can be provided using 1.78:1 ring to sun planetary ratio, and an extrapolation factor of 3.05, provided with a 3/05:1 ring to sun planetary ratio.

It should be appreciated that the in some embodiments, the fixed ratio gearing 22 and the planetary gear set 23 are optionally provided as an integrated variator having a common carrier of the type disclosed in U.S. patent application Ser. No. 12/527,400, which is hereby incorporated by reference. Likewise, fixed ratio gearing 22 and the planetary gear set 23 are optionally provided as an integrated variator having a common carrier.

While preferred embodiments have been shown and described herein, it will be obvious to those skilled in the art that such embodiments are provided by way of example only. Numerous variations, changes, and substitutions will now occur to those skilled in the art without departing from the invention. It should be understood that various alternatives to the preferred embodiments described herein are capable of being employed in practicing the invention. It is intended that the following claims define the scope of the invention and that methods and structures within the scope of these claims and their equivalents be covered thereby.

What is claimed is:

1. A powertrain comprising:
a main shaft;
a variator having a first plurality of balls, each ball provided with a tillable axis of rotation, each ball in contact with a first traction ring assembly and a second traction ring assembly, and each ball operably coupled to a first carrier assembly;
a first planetary gear set having a first ring gear, a first planet carrier supporting a first plurality of planet gears coupled to the first ring gear, and a first sun gear coupled to the first plurality of the planet gears; and
a second planetary gear set having a second ring gear, a second planet carrier supporting a second plurality of planet gears coupled to the second ring gear, and a second sun gear coupled to the second plurality of the planet gears,
wherein the first traction ring assembly is configured to receive a rotational power, the first traction ring assembly is operably coupled to the second sun gear,
wherein the second traction ring assembly is operably coupled to the first ring gear,
wherein the first planet carrier is operably coupled to the second planet carrier, and
wherein the first sun gear is operably coupled to ground.

2. The powertrain of claim 1, wherein second ring gear is configured to transmit a rotational power out of the powertrain.
